(19) United States
(12) Patent Application Publication
(10) Pub. No.: US 2004/0225711 A1
(43) Pub. Date: Nov. 11, 2004

(54) System for administering computers on a computing grid

(75) Inventors: Robert J. Burnett, Dakota Dunes, SD (US); Anthony M. Olson, Dakota Dunes, SD (US)

Correspondence Address: GATEWAY, INC., ATTN: SCOTT CHARLES RICHARDSON, 610 GATEWAY DR., Y-04, N. SIOUX CITY, SD, 57049, US

(73) Assignee: Spotware Technologies, Inc.

(21) Appl. No.: 10/431,669

(22) Filed: May 8, 2003

(51) Int. Cl. G06F 15/16; G06F 15/173

(52) U.S. Cl. 709/201; 709/226

(57) ABSTRACT

A system is disclosed for administering a computing grid including a grid manager computer and grid computers utilizing a communications network for permitting communication therebetween. A method aspect includes receiving a parameter communicated from each of a plurality of the grid computers, with the parameter characterizing an aspect of the grid computer communicating the parameter. At least two grid computers are logically grouped together in a virtual subgrid of grid computers on the computing grid. Each of the computers of the subgrid may have a similar level of the parameter, or may have a similar relationship to a reference level of the parameter. A job is assigned to one or more computers of the subgrid when the job requires a level of the parameter that that is characteristic of the grid computers of the subgrid.

### BACKGROUND OF THE INVENTION

1. Field of the Invention

The present invention relates to grid computing systems and more particularly pertains to a system for administering a grid computing system that more efficiently organizes and applies available resources on the grid computing system.

2. Description of the Prior Art

Grid computing, which is sometimes referred to as distributed processing computing, has been proposed and explored as a means for bringing together a large number of computers of wide ranging locations and often disparate types for the purpose of utilizing idle computer processor time and/or unused memory by those needing processing or storage beyond their capabilities. While the development of public networks such as the Internet has facilitated communication between a wide range of computers all over the world, grid computing aims to facilitate not only communication between computers by also to coordinate processing by the computers in a useful manner. Typically, jobs are submitted to a managing entity of the grid system, and the job is executed by one or more of the computers on the grid.

However, while the concept of grid computing holds great promise, the execution of the concept has not been without its challenges. One challenge associated with grid computing is the efficient organization and management of the highly diverse resources available on the grid system so that jobs submitted to the grid receive handling that is appropriate to each of the particular jobs.

Much of the development effort in grid computing has focused on defining a uniform interface and protocol for the computers of the grid so that jobs submitted to the grid may be performed by one, two, or even hundreds of computers in a coordinated fashion. The computers of the grid system are part of a general population of computers from which the managing entity of the grid system chooses one or more computers to process a job. When a job is submitted to the grid, the managing entity attempts to match the job with one or more computers that have the capability to process the job (or portions of the job) based primarily on the processing requirements of the job. This case-by-case matching process is better suited to grids with relatively smaller populations, as larger grid populations and greater job volume make this approach less feasible.

Another aspect of grid computing that has received some attention is the development of systems and methods for secure communication between computers of the grid system which may be remotely located with respect to each other. To encourage use of the grid system, potential customers must be confident of the security of the information included in jobs being submitted to the grid for processing or storage. Often jobs that have significant processing requirements or storage needs (and thus are probably the most suitable for processing on a grid system) are submitted by entities that require a high degree of security for their projects because they involve highly sensitive information.

One illustrative example of the grid systems previously proposed is disclosed in U.S. Pat. No. 6,463,457, which describes a fee-for-service system in which fees increase incrementally based upon an increased level of reliability of service and an increased level of security. As appears to be common in the security implementations of known grid systems, the security measures are primarily directed to maintaining the integrity of message transmissions, and message encryption is employed to secure the message transmission aspect of the grid system operation. The security measures of the grid system often end when the message transmission of the job ends, as the grid system typically lacks any significant ability to control security measures on the individual computers of the grid and typically are unaware of any security measures that have been taken for the compute, especially in larger grids.

In view of the foregoing, it is believed that there is a need for a system for gathering and using information about relevant aspects of the computers of a grid for providing users of the grid with the option to select between various levels of computer security, performance, and availability (among other characteristics) in performing jobs submitted to the grid.

### SUMMARY OF THE INVENTION

In view of the organizational limitations in the known grid systems, especially in the area of security, the present invention discloses a system for administering computers on a grid computing system for utilizing the specific strengths of the computers of the grid system in a more effective manner.

In one aspect of the invention, a method is disclosed for administering a computing grid including a grid manager computer and grid computers utilizing a communications network for permitting communication therebetween. The method includes receiving a parameter communicated from each of a plurality of the grid computers of the computing grid, with the parameter characterizing an aspect of the grid computer communicating the parameter. The method further includes logically grouping at least two of the grid computers together in a virtual subgrid of grid computers on the computing grid based upon the parameters communicated by the grid computers. The method also includes assigning a job to one of the grid computers of the virtual subgrid when the job requires a level of the parameter that has a similar relationship to the reference level of the parameter exhibited by the grid computers of the virtual subgrid.

In another aspect of the invention, a system is disclosed for administering a computing grid having a grid manager computer and grid computers utilizing a communications network for permitting communication therebetween. The system includes means for receiving a parameter communicated from each of a plurality of the grid computers of the computing grid, with the parameter characterizing an aspect of the grid computer communicating the parameter. The system further includes means for logically grouping at least two of the grid computers together in a virtual subgrid of grid computers on the computing grid based upon the parameters communicated by the grid computers, and means for assigning a job to one of the grid computers of the virtual subgrid when the job requires a level of the parameter characteristic of the grid computers of the virtual subgrid. In one implementation of the system, the means for receiving the parameter, the means for logically grouping the grid computers, and the means for assigning the job are resident on the grid manager computer.

In yet another aspect of the invention, a computer readable medium is disclosed that tangibly embodies a program of instructions and implements a method including receiving a parameter communicated from each of a plurality of the grid computers of a computing grid (with the parameter characterizing an aspect of the grid computer communicating the parameter), logically grouping at least two of the grid computers together in a virtual subgrid of grid computers on the computing grid based upon the parameters communicated by the grid computers, and assigning a job to one of the grid computers of the virtual subgrid when the job requires a level of the parameter characteristic of the grid computers of the virtual subgrid.

A significant advantage of the present invention is the ability to organize the grid computers in one or more virtual subgrids that each include grid computers sharing a similar level of a parameter that characterizes an aspect of the computer such as security, performance, or availability. Jobs submitted to the computing grid system that require a particular level of one or more of the parameters may then be directed to the appropriate virtual subgrid of grid computers sharing that parameter level.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred implementations of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagram of a computing grid system suitable for implementing the system of administering a computing grid according to the present invention.

FIG. 2 is a schematic diagram view of the computing grid system of the present invention that particularly illustrates a number of logical subsidiary grids, or subgrids, which include various groupings of computers in the computing grid system.

FIG. 3 is a schematic diagram of the computing grid system of the present invention that particularly shows an illustrative subgrid scheme based upon the relative security levels of the computers, and in which relatively lower security subgrids include computers of relatively higher security subgrids. Each of the rings represents a logical or virtual subgrid grouping of the grid computers positioned in the ring. (The network connections between the computers have been omitted for the purposes of clarity of illustration.)

FIG. 4 is a schematic flow chart of a method aspect of the present invention.

### DETAILED DESCRIPTION

With reference now to the drawings, and in particular to

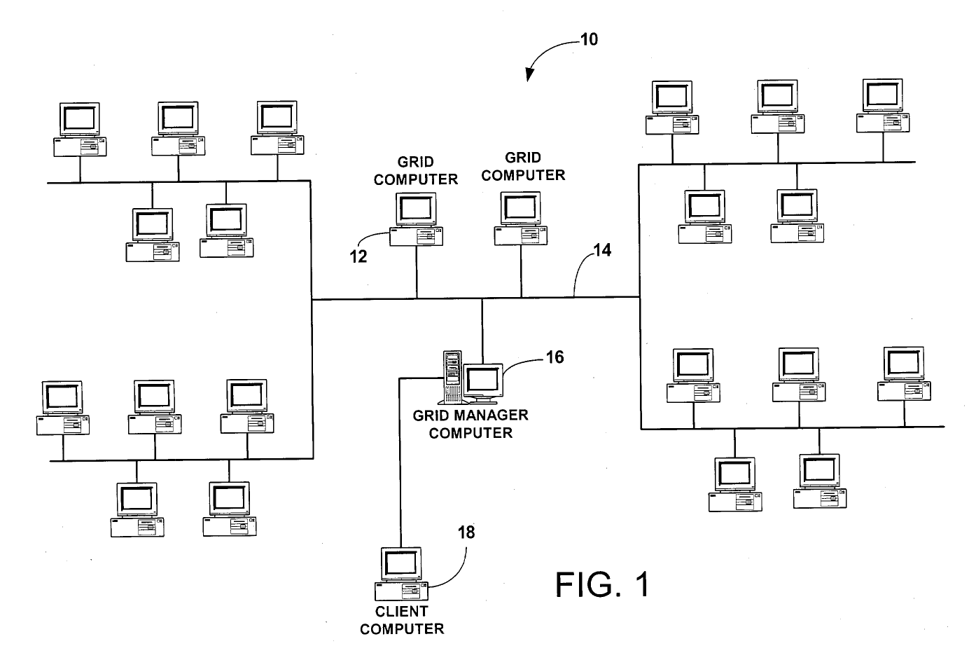

FIGS. 1 through 4 thereof, a system for administering a computing grid embodying the principles and concepts of the present invention will be described.

Initially, for the purposes of clarity in this description, terminology used throughout this description will be defined so as to minimize any confusion with respect to the disclosure of the invention, with the understanding that various other names may be given to the disclosed elements, and this terminology is not intended to be construed as limiting the invention.

A grid system 10 (see FIG. 1) may comprise a plurality of grid computers 12 linked or interconnected together for communication therebetween (such as by a linking network 14), with a grid manager computer 16 designated to administer the grid system. In operation, a client computer 18 submits a job to the grid system 10, typically via the grid manager computer 16, sometimes referred to as a grid server, which initially receives jobs for processing by the grid system. The client computer 18 may be one of the grid computers 12 on the grid system, or may be otherwise unrelated to the grid system 10. The grid manager 16 may be a network server adapted for accepting jobs from the client computer 18, assigning and communicating the job to one of the grid computers 12, receiving results from the grid computer, and communicating the final result back to the client computer. Optionally, the job may be submitted to more than one of the grid computers 12 of the system 10, and in that event the grid manager computer 16 may divide up or apportion the job into more than one subsidiary jobs, or tasks. The grid manager 16 then transmits the tasks to more than one grid computer 12 to be completed, and the results are returned to the grid manager, which correlates the results into a final result, and transmits them to the client computer 18.

In one embodiment of the invention, at least one of the grid computers 12 is located physically or geographically remote from at least one of the other grid computers, and in another embodiment, many or most of the grid computers are located physically or geographically remote from each other. The grid computers 12 and the grid manager computer 16 are linked in a manner suitable for permitting communication therebetween. The communication link between the computers may be a dedicated network, but also may be a public linking network such as the Internet.

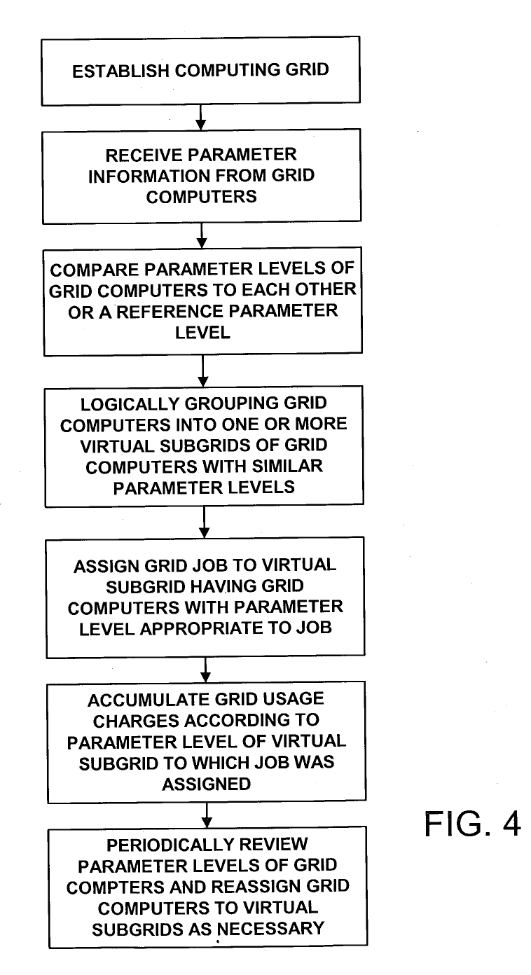

The invention contemplates a method of administering the computing grid system 10 (see FIG. 4). The administration of the grid system may include the formation of one or more groupings, or subsidiary grids, or subgrids 20, within the grid system 10. Each grid computer 12 on the grid system may be associated not only with the grid system generally, but may also be associated with one or more of the subgrids 20. The subgrids 20 may be created by virtually or logically associating two or more of the grid computers 12 of the grid system 10 together within the greater population of grid computers on the system.

To form the subgrids in a meaningful manner, each of the grid computers 12 may be characterized according to one or more parameters. As the grid computers 12 are unlikely to be uniform in character, there may be a significant range of variation in the parameters across the grid computers. While the grid system 10 generally benefits from having the processing power of a relatively large number of grid computers 12 available for performing jobs submitted to the grid system, the large population of grid computers may result in a wide variation in the types of computers that are employed on the grid, and the capabilities of those grid computers. This variation in the types of computers may be the result of, for example, variations in the primary use or purpose, ownership, age, manufacturer, and operating system software of the grid computer, among other variables.

Due to the security concerns that are often associated with computer grid systems, potentially the most significant parameter that may be used to characterize each of the grid computers is the relative level of security available on the grid computer for data processing that is performed by that grid computer. Optionally, the relative level of security available for the storage of data on the grid computer may also be used to characterize the overall security level of the grid computer. The security level of a grid computer may be assessed on the basis of a number of different factors considered alone or in a combination of the factors.

One factor that may be used to determine the level of security of a particular grid computer 12 is the type of access that is permitted to the grid computer. One type of access variable that may be considered is the physical location of the computer, such as, for example, in a secure computer facility of an institution or business, or in a person's home office, or even on the sales floor of a retail store. Another type of access variable is the type of people that have access to the particular grid computer, such as, for example, computing professionals or the general public. Yet another type of access variable is the number of people that have access, including direct physical access and network access, to the grid computer. A grid computer to which a relatively greater number of people have access may be considered to have a relatively lower level of security, while a grid computer to which a relatively lesser number of people have access may be considered to have a relatively higher level of security.

Another factor affecting security may be the character of access during different time periods, such that the level of security of a computer may change from one time period to the next time period. For a particular grid computer, those time periods when relatively more people have access to the computer may be considered to be periods of a relatively low level of security, while time periods when relatively fewer people, or no people, have access to the computer may be considered to be periods of a relatively higher level of security. As one illustrative example, if a grid computer is located in a retail store, such as a computer sales outlet, the grid computer may be considered to have a relatively lower level of security during business hours when the general public and employees have access to the grid computer, while the grid computer may be considered to have a relatively higher level of security during times when the retail store is closed to the public (such as during nighttime hours) and few, if any, employees have access to the grid computer.

Another factor to consider for determining the level of security is the type of usual, or normal, or primary use of the grid computer by the primary user. The primary use of a particular grid computer may require a higher relative level of security than is typically employed for enterprise or home computers, such as in the case of computers that are employed by companies in sensitive industries such as, for example, defense contractors.

Yet another factor that may be used to determine the level of security is the type of communication link between the grid computer and the grid manager computer and other grid computers on the system. This factor may include consideration of the network or networks over which communications pass between the grid computer and the grid manager computer. For example, a wireless or cable connection as a communications link may be considered to have a relatively lower level of security because this type of link is a broadcast transmission. Conversely, a dedicated T1 or fiber optic connection may be considered to have a relatively higher level of security because it is a point-to-point transmission. Further, another consideration is whether, and what type of, encryption may be applied to communications between the grid and the grid manager computers.

Thus, the relative level of security for a grid computer may be determined based upon a number of factors, and a characterization of the security level of each of the grid computers may be made in relation to the other grid computers.

Another parameter that may be used to characterize the grid computer may be the availability level of the grid computer for processing tasks that originate from the grid as compared to the processing of local tasks that are the primary function of the grid computer. This may be measured, for example, as the average amount of time per day that the grid computer is powered up and connected to the Internet (or other communications link), and thus potentially available for communication with and use by the grid system. Another possible manner in which the availability may be measured is the percentage of time that the grid computer, or the processor of the computer, is not otherwise involved in performing local tasks for the local user. In order to minimize the potential intrusiveness of grid system tasks upon the activities of the local user of the computer, the grid system may be implemented so that the tasks assigned to a grid computer by the grid manager computer are only performed during periods when local application programs are not actively running or using the processor of the computer. Thus, the percentage of the time that the computer is accessible (e.g., powered up and connected to the linking network) may be further reduced by the amount of that time that the local user's tasks are actively using the computer's processing resources. As will be appreciated, grid computers having a greater period of time over which the computer is not being actively used locally are more likely to be able to handle and complete grid-originated tasks in a quicker manner as compared to, for example, those grid computers which have a large amount of time devoted to executing local tasks. Moreover, grid computers that are only intermittently connected to the linking network are less likely to be able to quickly process and report back the results of a computing task.

Yet another possible parameter that may be used to characterize the grid computer is the performance level of the processor of the computer. The performance level may be measured by the processing speed of the grid computer, such as by measuring the speed of the processor, and even the speed of the buses communicating with the processor may be considered. The performance level may also be measured in terms of the mode of connection by the grid computer to the linking network (and the potential speed of such connection), such as dial-up modem, ISDN (Integrated-Services Digital Network), DSL (Digital Subscriber Line), T1, cable modem, satellite, wireless, or mobile. The performance level may also be measured by the actual, or average actual, connection speed (as contrasted with the potential speed) between the grid computer and the linking network or the grid manager computer.

It will be recognized that it is possible for one aspect of any grid computer to influence multiple parameters. For instance, as an example, a cable modem connection for a grid computer may provide better performance than a dial-up modem connection in terms of connection speed. However, the dial-up modem connection may provide relatively better security, by virtue of its point-to-point nature of transmission, than the broadcast nature of transmission of the cable modem connection.

Still other possible parameters for classifying and associating grid computers of the grid may be the relative size of memory and/or storage of the grid computer, and any particular software resident on the grid computer (such as, for example, the operating system software). Those in the art will appreciate that there are numerous other parameters that may potentially be used as a basis to classify computers and associate them into subgroups or subgrids of the grid computers.

While many of the foregoing examples of parameters may be reported or measured or otherwise established at the time that the grid computer is initially associated with the grid system, some parameters useful for grouping the grid computers may become apparent after a period of time of operation by a grid computer on the grid system. For example, the overall quickness and reliability of each of the grid computers in actually completing assigned tasks may be evaluated by the grid manager computer, and may be measured on an ongoing basis. These parameters may also form the basis for characterizing grid computers on the system to group the computers into one or more subgrids.

A profile of the grid computer, including one or more of the foregoing parameters, may be established, and such a profile may be established for each of the grid computers of the grid system. These profiles may be communicated to the grid manager computer by the grid computer or may be formed by the grid manager computer based upon parameters communicated to the grid manager. The profile or the parameters for the profile may be communicated at the request of the grid manager computer, or at the initial installation of a grid software application program on the grid computers. Thus, the communication of parameters may be accomplished at the time of adding the grid computer into the grid system, or at a relatively later time after the grid computer has become associated with the grid system. The grid manager computer receives the parameter or profile information and may save the information in a database.

Once the grid manager computer has received parameter or profile information from one or more of the grid computers of the pool or population of the grid system, the grid manager may compare the parameter levels of the computers to each other to determine what levels are relatively high, low, and intermediate (among other finer gradations). The grid manager may also compare the parameter levels to a reference or cutoff parameter level to determine which grid computers have parameter levels that fall below the reference level and which grid computers have parameter levels that exceed the reference level.

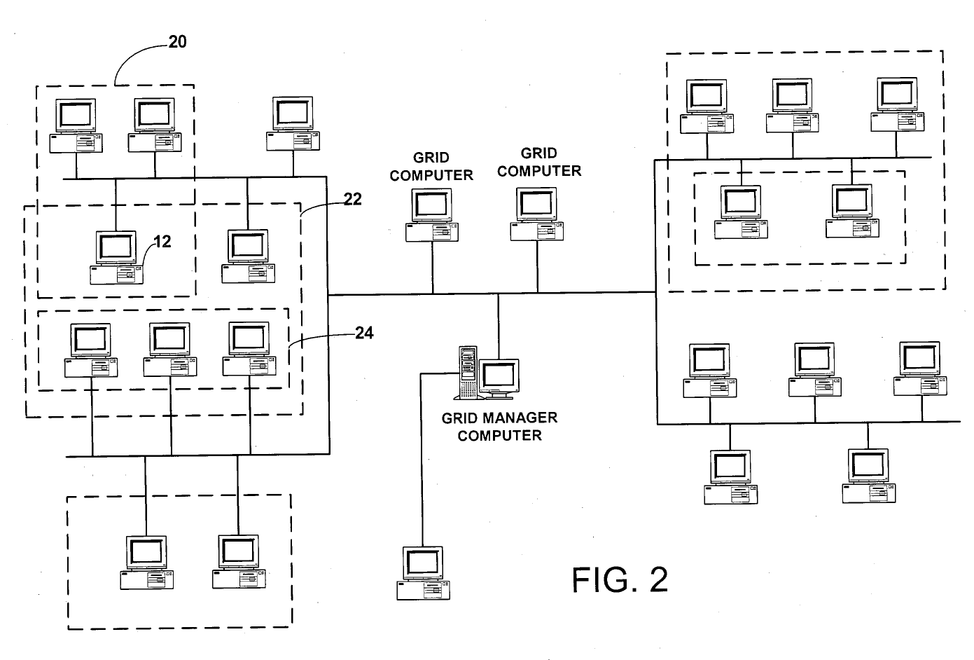

The grid manager may associate together in a virtual manner two or more of the grid computers having the same or similar values or levels for a particular parameter into a subgrid. The grouping of grid computers may be based upon a single parameter, or a combination of parameters. A grid computer 12 may be associated with a first subgrid 20 of computers having a same or similar level of a first parameter, and the grid computer may also be associated with a second subgrid 22 of computers having a same or similar level of a second parameter (see FIG. 2). The groupings of grid computers may be disjunctive, and not have any computers in common, or may overlap such that some computers are included in two or more of the groupings. These subgrid groupings may be based upon selections of parameters and relative parameter levels chosen by administrators of the grid system. For example, the administrator may decide to offer two, three, four or more different levels of security.

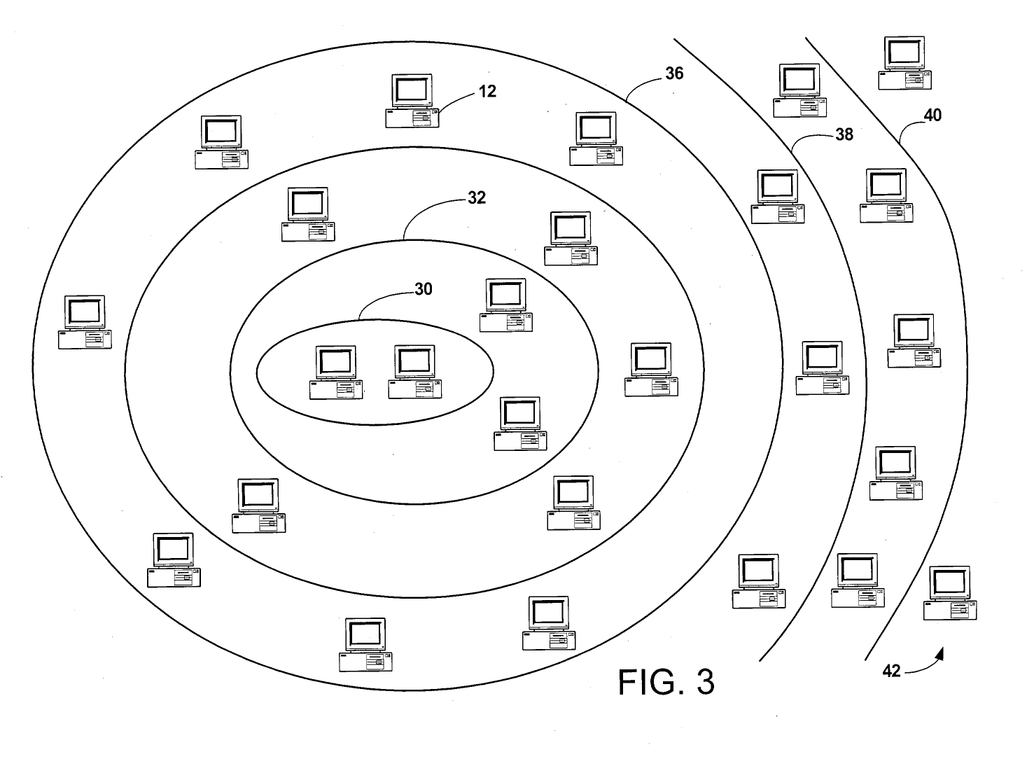

In an illustrative implementation of the invention, a plurality of subgrids is created based upon the relative level of security of the constituent computers (see FIG. 3). In this implementation, a subgrid comprised of grid computers of a particular relative security level also logically includes computers of subgrids having relatively higher levels of security. In this implementation, a first subgrid 30 is created that includes grid computers subject to the relatively highest level of security on the grid system. This first subgrid 30 may include, for example, computers that may be located in a relatively secure facility with restricted access and that may be dedicated to processing only tasks for the grid system without having any local tasks of significance to perform. A second subgrid 32 of a relatively lower level of security may also be created. The second subgrid 32 may include grid computers, for example, that are operated within a workgroup of computers of a company that are linked to the grid system. As noted above, the second subgrid 32 may include the computers of the first subgrid 30 as well as the computers within the particular workgroup. A third subgrid 34 of a still relatively lower level of security may be created, and may illustratively include grid computers within the same company of the workgroup. A fourth subgrid 36 may include computers of a yet relatively lower level of security, and may illustratively include computers of a particular group of companies.

A fifth subgrid 38 may include computers of a relatively lower level of security than the fourth subgrid, and may illustratively include grid computers resident in one or more retail stores. Optionally, the relative security level of the fifth subgrid 38 may be transient and thus may change, for example, between times when the general public has access to the computers of the retail stores (e.g., business hours), and times when access to the computers of the stores is relatively more limited (e.g., after business hours). A sixth subgrid 40 of an even relatively lower level of security may illustratively include the home or office computers of a customer base of a particular company or organization. A seventh subgrid 42 of a yet still relatively lower level of security may include the computers of an otherwise unrestricted population of computers, such as all of the constituent computers of the grid system.

In another illustrative implementation of the invention, one or more subgrids may be virtually created based upon the performance parameters of the grid computers. A subgrid may be created that includes grid computers that have performance parameters that are above a particular level, or fall within a range between two levels. For example, as illustrated in FIG. 2, the groupings of grid computers of the grid system may be applied so that one subgrid 20 includes only grid computers that have processor operating speeds below approximately 2 gigahertz, and another subgrid 24 includes only computers that have processor operating speeds greater than approximately 2 gigahertz. As another example, a subgrid 22 may include grid computers having processor operating speeds greater than 1 gigahertz, and another subgrid 24 may include only grid computers that have processing speeds greater than 2 gigahertz. Thus, the grid computers of the subgrid 24 may be included in the subgrid 22, as the processing speed parameter of the grid computers of the subgrid 24 also meets the requirements of the subgrid 22. It will be recognized that as improvements are made in the design and production of computers, the applicable processor operating speed parameter values may need to be adjusted, such as, for example, when faster processor operating speeds become available, and grid computers with relatively slower processor operating speeds are taken off of the grid system by their owners and are replaced with relatively faster grid computers.

The grouping of grid computers into various subgrids with varying levels of selected parameters permits a grid customer, or client computer, to submit a job to the grid manager with one or more conditions, or minimum parameter requirements, that need to be met by grid computers processing the job on the grid system. The grid manager computer may thus simply direct the job to one or more computers on the appropriate subgrid of grid computers meeting the minimum parameter requirements. The various levels of parameters available may be communicated to the client computer prior to job submission, and the grid customer thus has the option to select among the desired minimum levels, if any, of parameters of the grid computers handling the job. For example, restrictions may be set on the security level, processing speed, and other parameters by the grid customer or client computer submitting the job for the grid computers that process the job.

Significantly, as subgrids of computers may be formed based upon similar parameter levels, jobs submitted by a grid computer on a subgrid may be handled by one or more other grid computers on that subgrid. Thus, jobs that are submitted to the grid system by a grid computer on a subgrid may be automatically routed to one or more other grid computers on that same subgrid, thus providing the customer with a similar level of security, performance, availability, or other relevant parameter that characterizes the grid computer submitting the job. This is especially advantageous for subgrids established based upon a similar relative security level, so that jobs submitted to the grid system may be automatically processed at the same security level or a higher security level as the submitting grid computer.

The cost of performing a job on the grid system may be set or calculated according to any requirements for minimum parameter levels that are attached to the submission of a job to the grid system for processing. Requests for processing of jobs at relatively higher parameter levels, and the resulting assignment of the jobs to particular subgrids meeting those parameter requirements, may be associated with higher costs or charges for the job processing. For users of grid computers participating in the grid system, credits may be awarded for jobs performed by the user's grid computer, while debits may be assessed to the user for jobs that are performed for the user by other grid computers on the system.

As the grid system is maintained, additional grid computers may be added to the grid system, and parameter information may be obtained from any added grid computers for the purpose of associating the added computers with one or more of the virtual subgrids, as well as the grid system in general. Optionally, if a change is made to the configuration or other characteristics of the grid computer that might affect one or more of the parameters of the computer, the changes in the parameters may be communicated to the grid manager computer for possible reclassification or reassignment of the computer by the grid manager computer among the subgrids of the grid system. In particular, as the configurations of the grid computers are changed, and the parameters that characterize the computer in the grid system are thereby changed, the grid computer may be added to or subtracted from one or more of the virtual subgrids so that the character of the subgrid is maintained. Periodic checks, or rechecks of the parameters of the grid computers may be initiated, such as by the grid manager computer, to facilitate the maintenance of the character of the subgrids.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in. the drawings and described in the specification, including all suitable modifications, are intended to be encompassed by the present invention that fall within the scope of the invention.

We claim:

1. A method of administering a computing grid having a grid manager computer and grid computers utilizing a communications network for permitting communication therebetween, comprising steps of:
receiving a parameter communicated from each of a plurality of the grid computers of the computing grid, the parameter characterizing an aspect of the grid computer communicating the parameter;
logically grouping at least two of the grid computers together in a virtual subgrid of grid computers on the computing grid based upon the parameters communicated by the grid computers; and
assigning a job to one of the grid computers of the virtual subgrid when the job requires a level of the parameter characteristic of the grid computers of the virtual subgrid.

2. The method of claim 1 additionally comprising accumulating grid usage charges for a user of the computing grid based on assignment of a job of the user to the virtual subgrid.

3. The method of claim 1 additionally comprising comparing levels of the parameters communicated by the plurality of grid computers on the computing grid to a reference level of the parameter.

4. The method of claim 1 wherein the step of logically grouping at least two of the grid computers together includes forming at least two virtual subgrids of the grid computers based upon at least two different levels of the parameter communicated by the plurality of grid computers.

5. The method of claim 1 wherein the step of logically grouping at least two of the grid computers together includes forming at least two virtual subgrids of the grid computers based upon at least two different parameters communicated by the plurality of grid computers.

6. The method of claim 1 wherein the aspect of the grid computer characterized by the parameter is a relative level of security of the grid computer with respect to levels of security of the plurality of grid computers on the computing grid.

7. The method of claim 6 wherein the parameter is a type of access to the grid computer.

8. The method of claim 6 wherein the parameter is a type of location of the grid computer.

9. The method of claim 6 wherein the parameter is a type of persons having access to the grid computer.

10. The method of claim 6 wherein the parameter is a number of persons having access to the grid computer.

11. The method of claim 6 wherein the parameter is a type of primary use of the grid computer.

12. The method of claim 6 wherein the parameter is a type of communication link between the grid computer and the grid manager computer.

13. The method of claim 1 wherein the aspect of the grid computer characterized by the parameter is a relative level of availability of the grid computer with respect to levels of availability of the plurality of grid computers on the computing grid.

14. The method of claim 1 wherein the aspect of the grid computer characterized by the parameter is a relative level of performance of the grid computer with respect to levels of performance of the plurality of grid computers on the computing grid.

15. The method of claim 1 wherein all of the grid computers of the virtual subgrid have a level of the parameter that is greater than a reference level of the parameter

16. The method of claim 1 wherein all of the grid computers of the virtual subgrid have a level of the parameter that is less than a reference level of the parameter.

17. The method of claim 1 wherein the virtual subgrid comprises a first subgrid, and additionally comprising logically grouping at least two grid computers together in a second virtual subgrid on the computing grid, wherein the grid computers of the first virtual subgrid have levels of the parameter greater than or equal to a reference level of the parameter and the grid computers of the second virtual subgrid have levels of the parameter less than or equal to the reference level of the parameter.

18. A system for administering a computing grid having a grid manager computer and grid computers utilizing a communications network for permitting communication therebetween, comprising:
means for receiving a parameter communicated from each of a plurality of the grid computers of the computing grid, the parameter characterizing an aspect of the grid computer communicating the parameter;
means for logically grouping at least two of the grid computers together in a virtual subgrid of grid computers on the computing grid based upon the parameters communicated by the grid computers; and
means for assigning a job to one of the grid computers of the virtual subgrid when the job requires a level of the parameter characteristic of the grid computers of the virtual subgrid.

19. The system of claim 18 additionally comprising the grid manager computer, and wherein the means for receiving the parameter, the means for logically grouping the grid computers, and the means for assigning the job are resident on the grid manager computer.

20. The system of claim 18 additionally comprising means for accumulating grid usage charges for a user of the computing grid based on assignment of a job of the user to the virtual subgrid.

21. The system of claim 18 wherein the means for logically grouping at least two of the grid computers together includes means for forming a plurality of the virtual subgrids of the grid computers of the computing grid based upon at least two different levels of the parameter communicated by grid computers.

22. The system of claim 18 wherein the means for logically grouping at least two of the grid computers together includes means for forming a plurality of virtual subgrid based upon at least two different parameters communicated by the plurality of grid computers.

23. A computer readable medium tangibly embodying a program of instructions implementing the following method:
receiving a parameter communicated from each of a plurality of the grid computers of a computing grid, the parameter characterizing an aspect of the grid computer communicating the parameter;
logically grouping at least two of the grid computers together in a virtual subgrid of grid computers on the computing grid based upon the parameters communicated by the grid computers; and
assigning a job to one of the grid computers of the virtual subgrid when the job requires a level of the parameter characteristic of the grid computers of the virtual subgrid.

24. The computer readable medium of claim 23 further implementing accumulating grid usage charges for a user of the computing grid based on assignment of a job of the user to the virtual subgrid.

25. The computer readable medium of claim 23 further implementing comparing levels of the parameters communicated by the plurality of grid computers on the computing grid.

26. The computer readable medium of claim 23 wherein logically grouping at least two of the grid computers together includes forming at least two virtual subgrids of the grid computers based upon at least two different levels of the parameter communicated by the plurality of grid computers.

27. The computer readable medium of claim 23 wherein the parameter comprises a first parameter, and further implementing receiving a second different parameter communicated from each of the plurality of the grid computers, and wherein logically grouping at least two of the grid computers together includes forming at least two virtual subgrids of the grid computers based upon the first and second parameters communicated by the plurality of grid computers.

28. The computer readable medium of claim 23 wherein the virtual subgrid comprises a first subgrid, and further implementing logically grouping at least two grid computers together in a second virtual subgrid on the computing grid, wherein the grid computers of the first virtual subgrid have levels of the parameter greater than or equal to a reference level of the parameter and the grid computers of the second virtual subgrid have levels of the parameter less than or equal to the reference level of the parameter.
